(19) United States
(12) Patent Application Publication
(10) Pub. No.: US 2008/0215476 A1
(43) Pub. Date: Sep. 4, 2008

(54) ANONYMOUS BIDDING SYSTEM

(76) Inventors: Nancy J. Rabenold, Brandon, FL (US); James A. Simmons, Brandon, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/060,293

(22) Filed: Apr. 1, 2008

Related U.S. Application Data
(63) Continuation of application No. 11/048,102, filed on Jan. 31, 2005.
Application No. 11/048,102 is a continuation-in-part of application No. 10/913,161, filed on Aug. 6, 2004.
Application No. 10/913,161 is a continuation of application No. 09/866,191, filed on May 25, 2001, now Pat. No. 6,813,612.
(60) Provisional application No. 60/540,531, filed on Jan. 30, 2004.
(60) Provisional application No. 60/207,030, filed on May 25, 2000.

(51) Int. Cl. G06Q 30/00

(52) U.S. Cl. 705/37

(57) ABSTRACT

An anonymous bidding system that allows bidders to participate in a live auction by placing bids for items, but that does not disclose the identify of the bidding parties. Bidding participants may utilize a bidding device, such as a handheld device, to receive information regarding the auction. This information can include a description of the item up for auction, the asking price, and the current high bidder. By actuating the bidding device, a signal is sent to the bidding system to indicate that a bid request is being submitted. The bid request includes a bidder identifier that is unique to the bidding party, but that does not disclose the identify of the bidding party to others in the audience. Thus, the parties can participate in the live auction without drawing attention to their participation.

### CROSS-REFERENCE TO RELATED APPLICATIONS

This application for a United States Patent is a continuation-in-part of U.S. patent application filed on Aug. 6, 2004 and assigned Ser. No. 10/913,161, which application is a continuation of U.S. patent application Ser. No. 09/866,191 filed on May 25, 2001 and issued as U.S. Pat. No. 6,813,612 on Nov. 2, 2004, which further claims the benefit of the filing date of U.S. Provisional Application for Patent having been assigned Ser. No. 60/207,030, and filed on May 25, 2000. This application also claims the benefit of the filing date of U.S. Provisional Application for Patent that was filed on Jan. 30, 2004 with the title of “Autonomous Bidding System” and assigned Ser. No. 60/540,531.

This application incorporates herein by reference each of the above-listed applications and/or patents, as well as any documents that they incorporate by reference.

### BACKGROUND OF THE INVENTION

This invention relates generally to auctioning technology and, more specifically to a technique to allow onsite participants in a live auction to bid anonymously and that allows for the collection of bidding demographic data regarding the bidding history for the auction.

Traditional style auctions are at a competitive disadvantage to online auctions when it comes to providing anonymous bidding capability for the bidders attending a live traditional style auction, as well as analyzing the bidding actions of all bidders.

For instance, bidders participating in an online auction have the ability to select a screen bidder name that shields or protects their identity. This anonymity is important in many business-to-business auctions because often, the bidder is bidding against his/her regional competitor. In such a situation, if the competitor learns it is his/her regional competitor bidding, the competitor may continue bidding simply in an effort to raise the price that his/her competitor must pay to win the item. When a bidder becomes an active bidding participate in a live traditional auction his/her bids are visibly recognized by either an auctioneer or ring person alerting his/her regional competitor to his/her bid. Thus, there is a need in the art for a system that allows a bidder to actively participate in a traditional style auction anonymously without sacrificing the integrity of the traditional style auction.

Inherent in the online auction technology is the ability to capture every single bid submitted (even including bids that are not accepted) as well as the true identity of the bidder submitting the bid. This all-inclusive bidding data is one of the crucial elements in allowing online auctions to provide several custom services. Some of these custom services include:
1) Providing predictive modeling algorithms to a consignor enabling them to offer the item through the most effective channel and/or to the most effective audience thereby significantly increasing the potential of achieving the maximum value of the item being sold.
2) Reducing the amount of data the bidders must process by providing them with information on the items they are most likely to purchase versus information for all the items in the sale.
3) Implementing regional, focused or customized marketing programs targeted at regional or specific sets of bidder.

Limited by the speed of the traditional auction event—selling 180 items per hour with approximately ten to twenty bids per item—the traditional auction industry has, historically, not been able to track the bidding activity. It simply records the identity of the winning bidder and the item that the winning bidder purchased. Thus, the traditional auction event is simply deprived of the above-described custom services, as well as other disadvantages.

Thus, there is a need in the art for a system and/or method that enables traditional auction industry to compete with the online auction industry be offering similar custom services that are available to the online auction customers. Furthermore, there is a need in the art for such a system or method to maintain the anonymity of the auction participant yet enables the auction company to track all bidding activity for all participating bidders.

### SUMMARY OF THE INVENTION

In general, aspects of the present invention enable an onsite bidder participating in a live auction to maintain anonymity. Other aspects of the present invention enable the gathering, recording and manipulation of statistical information related to onsite auction bidders similar to what is available in the online auction setting.

More specifically, one aspect of the present invention relates to a bidder attending and anonymously participating in a live traditional-style auction conducted by a live auctioneer in the presence of onsite bidders. This aspect of the present invention can include four primary modules: (1) a handheld bidding device which the bidder uses to anonymously participate in the auction, (2) a clerk device which is used to input the auctioneer's actions, (3) a bid engine which transmits the clerk's messages to the handheld devices, receives bids from the handheld devices and retransmits them to the clerk and/or marquee device, and (4) a marquee device which displays the anonymous bids to the auctioneer and local audience. Such a system is referred to within this specification as the anonymous bidding system (ABS).

Each bidder using the ABS interacts with a handheld device that allows him or her to (a) anonymously submit real-time bids for items currently being auctioned by the auctioneer, (b) submit proxy bids for items that are not yet on the auction block and (c) review sale inventory items and schedules—all from the auction lane, ring, parking lot, in view of the auctioneer and the local audience. The bidder ensures his or her anonymity by selecting a display name that is then linked by the ABS to his or her true identity. The display name is the only name viewed by the auctioneer, clerk or local audience.

An administrator follows the auctioneer's incrementing and decrementing of the ask price (or accepted bid) by selecting the appropriate value through an interface that presents typical auctioneer increments and decrement values based upon the current money or the auctioneer's previously asking price. The updated price is then transmitted to the Bid Engine where it is logged and transmitted to all appropriate handheld devices.

As bids are submitted by the various handheld devices, the Bid Engine compares the received bids to the current ask price and other submitted bids. If the Bid Engine determines that a received bid is a valid bid, the bid is transmitted to the clerk system, the marquee display and even the other handheld devices.

The auctioneer or a ring person monitors the marquee display to identify incoming anonymous bids from the handheld devices. When the anonymous bids are accepted or rejected by the auctioneer, the clerk transmits a message to the Bid Engine, which in turn updates all the clerk, marquee and handheld devices.

Along with serving as the central communications device, the Bid Engine logs all clerk and handheld device activity into a historical bid log. The historical bid log can then be used by the auction company to determine bidder profiling data for the anonymous bidders, as well as profiling sale item data. For example, the profiling information can identify who from what region is interested in which types of sale items.

One embodiment of the invention is a system for enabling the entrance of anonymous bids into a traditional style live auction. In this embodiment, the system includes a plurality of bidding devices, a bid engine function that is communicatively coupled to each of the plurality of bidding devices and a clerk function that is communicatively coupled to the bid engine function. The clerk function operates to access item information related to an item to be offered for auction. This information can be stored within the clerk function, accessed from an external storage device, or loaded into the clerk function in real-time. The clerk function also receives bidding parameters such as the asking price, the bid increment levels, the credit score acceptable to be an active bidder, or the like. The clerk function then provides the item information and the bidding parameters to the bid engine function.

The bid engine function, upon receiving the item information and the bidding parameters, forwards this information to each of the plurality of bidding devices. The bidding devices, if so configured, can display all or a portion of the item information and the bidding parameters. Users may then actuate the bidding device to place a bid for the item being auctioned. The bidding devices generate a bid request and provide the bid request to the bid engine function.

Upon receiving a bid request, the bid engine function forwards the bid request to the clerk function. The clerk function then offers the bid to the auctioneer who can accept or reject the bid. The acceptance or rejection of the bid can be subsequently provided to the bid engine function in the form of updated bidding parameters.

Other embodiments and other aspects of the present invention will be more specifically described in conjunction with the detailed description.

### BRIEF DESCRIPTION OF THE DRAWINGS

FIG. 1 is a block diagram illustrating the various basic elements of the ABS.

FIG. 2 is an exemplary representation of a typical historical bid log that can be generated and maintained by the bid engine 120 during the auction event.

FIG. 3 is a block diagram illustrating one potential configurations using an untethered wireless approach.

FIG. 4 is a block diagram illustrating another potential configurations using an untethered wireless approach.

FIG. 5 illustrates an exemplary user interface embodiment for the handheld device.

FIG. 6 is a state diagram illustrating the process for a bidder utilizing an exemplary embodiment of the handheld device to join an auction event.

FIG. 7 is a state diagram illustrating the initial bid state.

### DETAILED DESCRIPTION OF EMBODIMENTS OF THE INVENTION

The accompanying drawings and the description which follows set forth exemplary embodiments of various aspects and/or features of the present invention. It should be appreciated that the embodiments described may include all of the aspects of the present invention or may include only some of the aspects of the present invention. Thus, although the present invention may encompass all of the described aspects, subsets of the aspects and/or features may also constitute an invention.

An exemplary embodiment of the present invention will be described in the three subsections that follow. In the first subsection the overall architecture of the Anonymous Bidding System (ABS) is presented. The handheld user interface is defined in the second subsection. In the third subsection the basic states of the Bid Engine are described.

Anonymous Bidding System Architecture

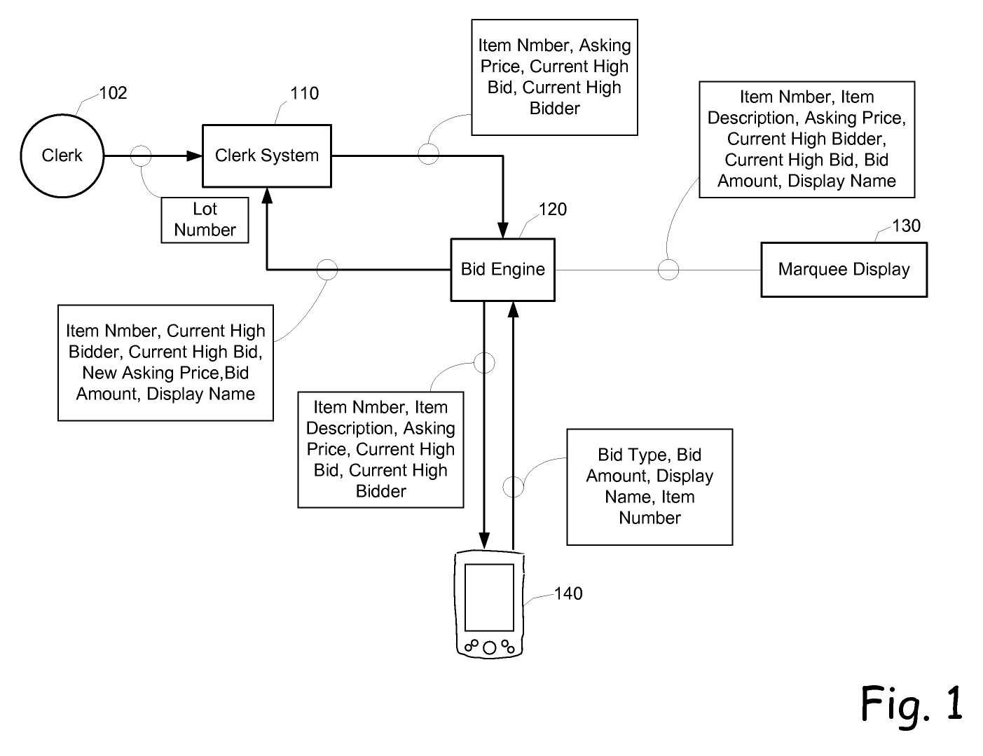

FIG. 1 is a block diagram illustrating the various basic elements of the ABS. The ABS includes a clerk system 110, a bid engine 120, a marquee display 130 and a handheld bidding device 140. It should be appreciated that the ABS can include many other elements and components but for the purposes of illustrating this embodiment of the present invention, only a few of the elements are presented.

An auction event begins with the clerk 102, or some other entity such as the auctioneer or an assistant, entering or selecting the item or lot number of the first item to be offered up for sale into the clerk system 110. Each item to be sold in the auction event can be previously loaded into the clerk system 110 and thus, identifying the item or lot number can be a simple selection process. However, it should be appreciated that the information can be entered at the time the item is brought up for sale or imported from another system or a database.

The item number along with the auctioneer's initial asking price, the current high bid and the identity of the high bidder are then sent to the bid engine 120. For the initial offering of the item for sale, the current high bid and the identity of the high bidder are null fields because no bids have yet been accepted.

The bid engine 120 then updates the clerk system 110, marquee display 130 and handheld devices 140 with the item's lot number, the new auctioneer's asking price and the current high bid and current high bidder. Again, the current high bid and high bidder are null fields at this point. If no bids are received, the auctioneer can either request a lower price or move on to the next item. If the auctioneer requests a lower price, the clerk 102 selects the decrement amount on the clerk system 110 and the lot number with a new ask price and nulls for current high bid and high bidder are then transmitted to the bid engine for rebroadcast.

The auctioneer responds to three different types of bids: (1) traditional bids from the onsite audience, (2) bids placed by a handheld device and (3) bids placed by other remote bidders. The auctioneer can accept or reject bids in the traditional method from the onsite audience. If a bid is submitted via the traditional method from the onsite audience, the auctioneer will revise his or her chat to reflect a new current money value as well as a new ask price. The administrator will acknowledge the revised price by selecting a new ask price and transmitting it to the bid engine 120. The bid engine 120 will check to determine if any handheld bids are pending. If handheld bids are pending for the previous asking price, the bid engine will update the current high bidder to reflect the display name of the anonymous bidder and the current high bid amount to the previous asking price. If no handheld bid is pending the bid engine 120 will update the current high bidder to reflect “Floor” or “Onsite” and the current high bid amount to the previous asking price. The updated current high bid, current High bidder, new ask price and lot number are then transmitted to the clerk system 110, the marquee display 130 and handheld devices 140.

The second type of bid that the auctioneer responds to is an anonymous bid from a handheld device. In this scenario, the handheld user enters the bid in real-time via the handheld device 140. The handheld device 140 transmits the bid amount, item number, bid type and the display name of the anonymous bidder to the bid engine 120.

The bid engine 120 then determines if the bid is valid (i.e., does the value match the asking price etc.) Following the validation of the bid, the bid engine 120 sends the bid information to the clerk system 110 and the marquee display 130. The marquee display 130 then begins flashing the bid amount and the display name of the anonymous bidder and continues flashing until the auctioneer either accepts or rejects the bid. In one embodiment, the acceptance or rejection of the bid can be accomplished via raising the asking price.

If the system automatically assigns the current high bidder status incorrectly to a handheld or autonomous bidder, the clerk can simply revert back to a current high bidder status of “Floor” through selecting a “floor overview” function on the clerk system.

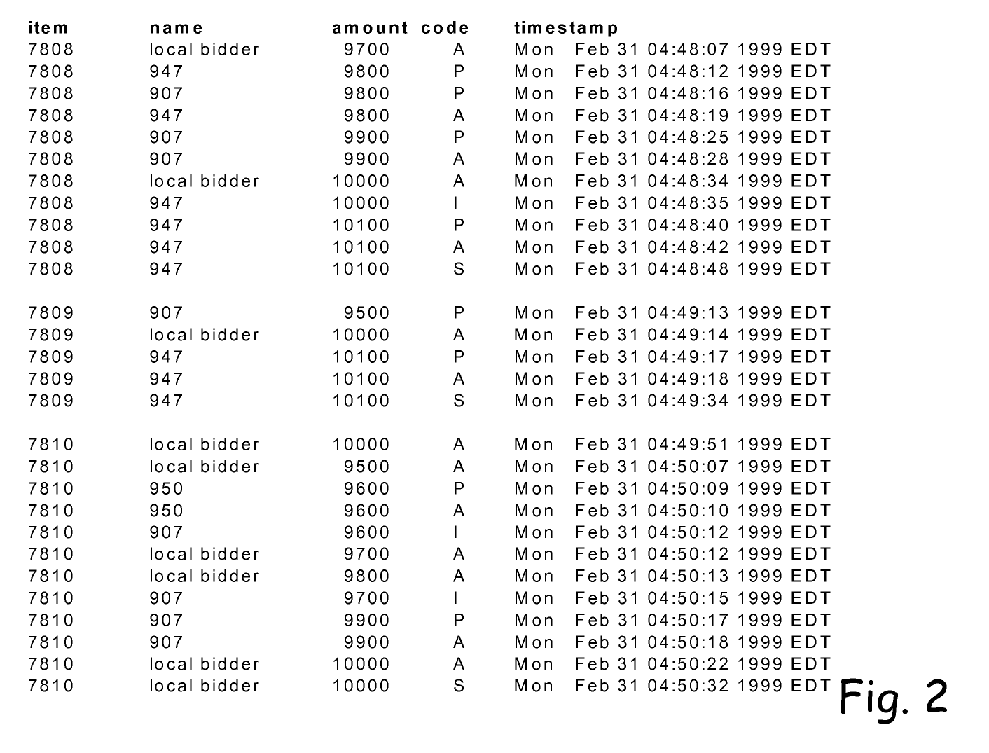

FIG. 2 is an exemplary representation of a typical historical bid log that can be generated and maintained by the bid engine 120 during the auction event. Using this data, the bidder profiles of the users of the ABS system can be evaluated.

The connectivity between the basic elements illustrated in FIG. 1 can be accomplished through various methods that best fit the needs of the auction company. In the most appropriate embodiments, the selected connectivity is implemented in a manner to provide a true real-time connection protocol. Significant delays or non-real-time connectivity can potentially place the ABS user at a disadvantage. In defining the system connectivity, it is beneficial to separate the connectivity between the clerk system 110, the bid engine 120 and the marquee display into one category and the connectivity between the handheld devices 140 and the bid engine into a second category.

The connectivity between the clerk system 110, the bid engine 120 and the marquee display can be achieved in many methods. In one embodiment, the clerk system 110 communicates with the bid engine 120 and the bid engine 120 to the clerk system 110 and the marquee display 130 using Internet Protocol and basic Local Area Network and wireless technologies. Using a centralized implementation, the clerk system 110, the bid engine 120 and the marquee display 130 would all be centrally located at the auction site. In a distributed strategy, the clerk system 110 and the marquee display 130 could be located at the auction site and communicate over the Internet to the bid engine 120. Also in a distributed approach the clerk system 110 and the marquee display 130 could be offsite from the auction and located in a central clerking location with the clerk and ring person (monitoring the marquee display 130) and communicating with the onsite auction staff or auctioneer via any voice or data communication technologies. The distributed approach could also be a advantageous if the ABS was used in conjunction with a remote bidding system (such as described in U.S. Pat. No. 6,813,612). The architecture of the ABS is not limited by the connectivity between the clerk system 110, the bid engine 120 and the marquee display 130 and the aforementioned embodiments are simply provided for purposes of illustration. It will be appreciated that as new technologies become practical, any type of real-time or substantially real-time connectivity can be utilized. Collocation of the items being auctioned is also not a requirement nor is it prohibited.

Connections between the handheld devices 140 and the bid engine 120 can be accomplished using either tethered (in the situation where the bid engine 120 is located at the auction site) or untethered approaches. The selection of tethered versus untethered is not a technical decision, but rather it is a practical business process decision. For example, in a fine art auction where the audience is generally seated and doesn't move around frequently, a tethered approach may be acceptable. Alternatively, for an auto auction consisting of multiple lanes where the dealer may actually visit several lanes during the sale, a tethered approach is likely not to be feasible.

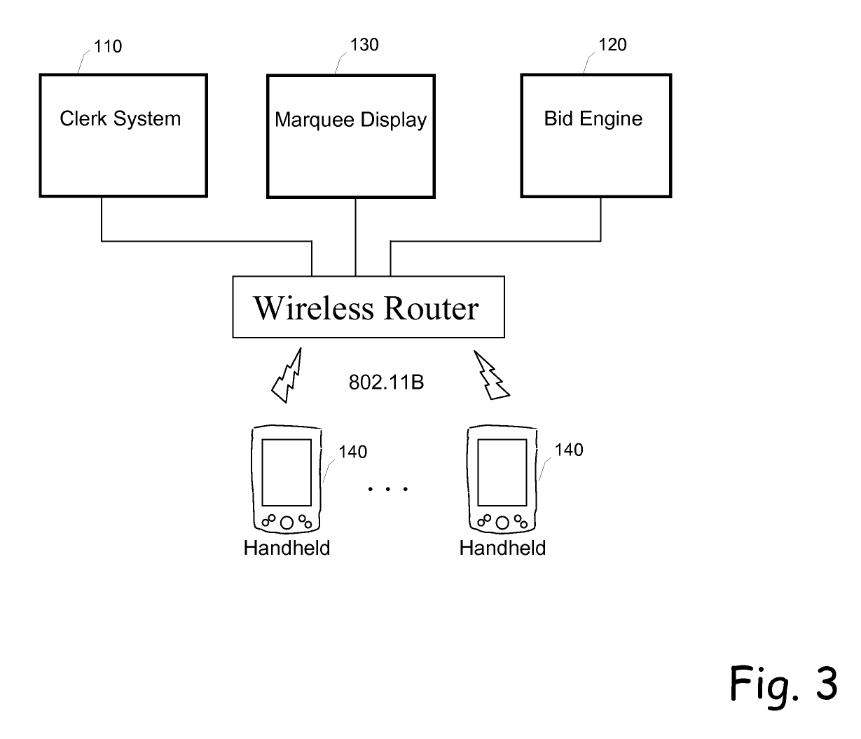

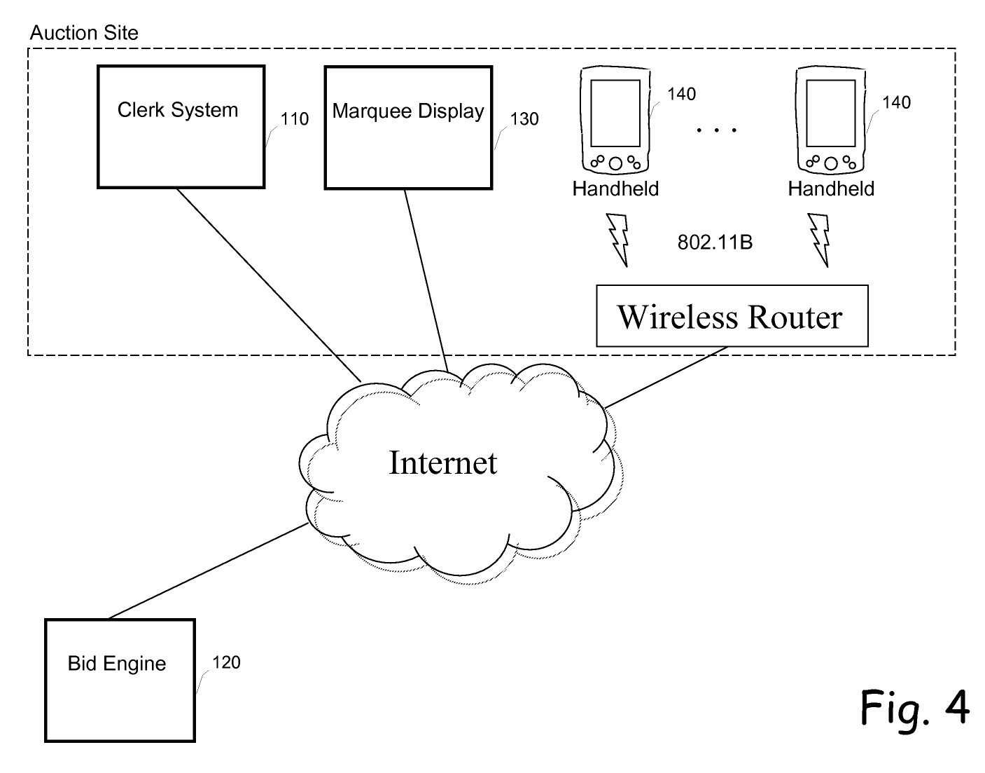

In an exemplary embodiment, the connectivity between handheld devices 140 and the bid engine 120 would be based on a wireless technology such as, but not limited to, IEEE 802.11 WiFi or WiMax approach. However, other technologies such as BlueTooth, cellular, unlicensed frequency RF transmission, INFRARED or other similar wireless or untethered technologies, as well as technologies developed in the future may also be employed. FIGS. 3 and 4 are block diagrams illustrating potential configurations using an untethered wireless approach.

In one embodiment of the ABS, the function of the connectivity strategy is not intended to isolate the exact location of the user or anonymous bidder. This embodiment is well suited within the context of automotive auctions or other auctions that are simultaneously conducting multiple rings or events at the same location. A bidder standing in one lane of the auction can access the bid engine 120 and log into multiple rings, lanes or events at the same time. In such an embodiment, it is the bidder's responsibility to access the multiple lanes and bid on the appropriate item. However, it is anticipated that other embodiments may be location dependent. Utilizing location technology such as RFID or GPS can be utilized to track the bidder as he or she moves from one location to the next and make the appropriate lane, ring or event modifications. Thus, in such an embodiment, the physical location of the bidder could identify the item for which the bidder is bidding

Handheld Device User Interface

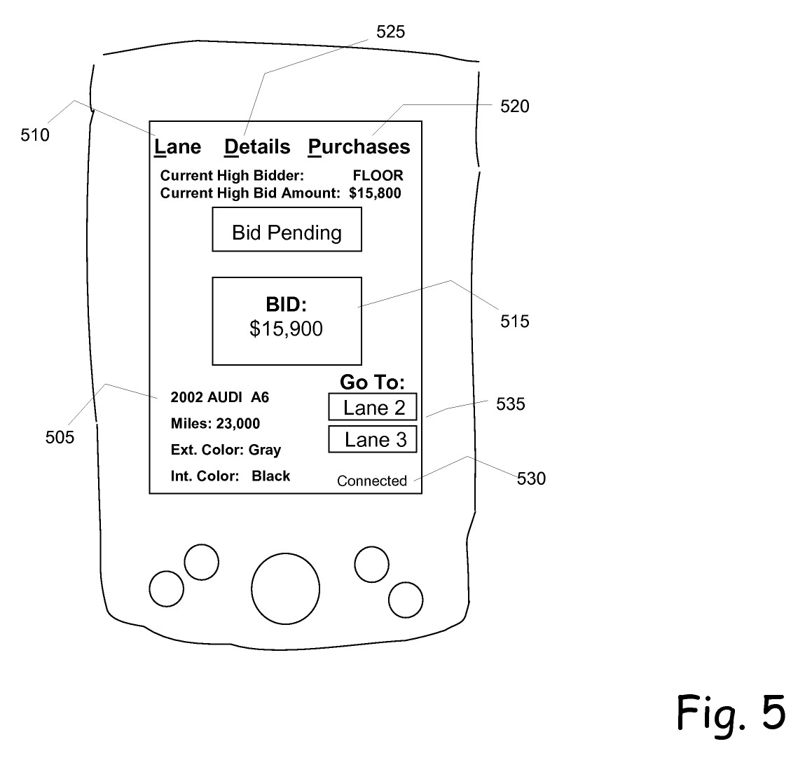

The handheld device user interface is typically dependent on the actual device type itself. For example, in a tethered environment, the handheld device can be as simple as a bombardier button. In an untethered environment, the handheld device can be as complex as a Personal Digital Assistant (PDA) (such as a Palm Pilot or iPAQ) or a smart phone or cellular phone. FIG. 5 illustrates an exemplary embodiment of a user interface for the handheld device.

In the illustrated embodiment, six distinct areas characterize the user interface:
1) Item Description 505
2) Lane Number 510
3) Bid Button 515
4) Credit/Purchases Tab 520
5) Information/Details Tab 525
6) Connectivity Status 530

Once the bidder arrives at the auction event, the bidder will have the ability to login into the network using either an auction provided mobile device or a bidder's personal device. Due to the fact that wireless technology can allow mobile devices within range to attempt to connect, the auction site can advantageously control access by either handing out login names and passwords when the bidder checks in or limiting access to certain MAC addresses or both. By implementing such procedures, the site can control who can access their network.

Once a user has logged into the auction site's network, he or she will need to access the auction event itself. The bidder will select his or her display name prior to logging into the actual event.

The item description area 505 enables the bidder to have a quick snapshot look at the item that they are bidding. Due to the fact that the bidder will be on site and knows the items coming up for auction, this is just a key reminder as to what vehicle they are interested in entering a bid. Once the auction has been completed for a specific item, the information in the description area 505 will change to reflect the new item based on the lane assignment for that section.

The Lane Numbers areas 535 define what other lanes are active. In order for the bidder to changes lanes, they would click on the Lane Number box they wish to change to and then select from a list of available lanes.

In order for a bidder to place a bid, they would select the BID button 515 above the item description of choice. The BID button 515 is broken into 2 areas. The bidder cannot change the lower portion of the button 515 and it displays the current bid amount as it changes. If the bidder has not placed a bid, it will remain white. If the bidder has placed a bid on that auction item, and the bid has been outbid or rejected, the bid button 515 turns Red. If the bid has been received and accepted, the bid button 515 will turn Green.

Once an item is sold, it will state SOLD (Red in color) on the BID Button 515 until another item is in that specified lane.

At any time during the auction event, the bidder can take a look at their credit limit. By selecting the Credit Tab 520, a window will open and present the user's remaining or total credit limit depending on how the auction site maintains this part of the system. The window will display the credit amount and allow the bidder to close the window and continue bidding.

If a bidder would like to have more information on an item, the bidder can select the description area of that item and it will be highlighted. The bidder can then select the Details TAB 525 at the top of the screen and the detailed information for that item will be displayed on the screen in a pop-up window. The bidder would then select CLOSE the pop-up window to return to the main screen.

By looking at the bottom right hand corner of the screen, the bidder can see the connectivity status of their device 530. If the device states Connected (Green in color) then they can bid successfully. If for any reason the status states Disconnected (Red in color) then the bidder has lost connection and can no longer bid. Once a device has lost connectivity, the screen becomes locked and will not allow the bidder to make any selection until the connectivity issue has been resolved.

### Bid Engine States

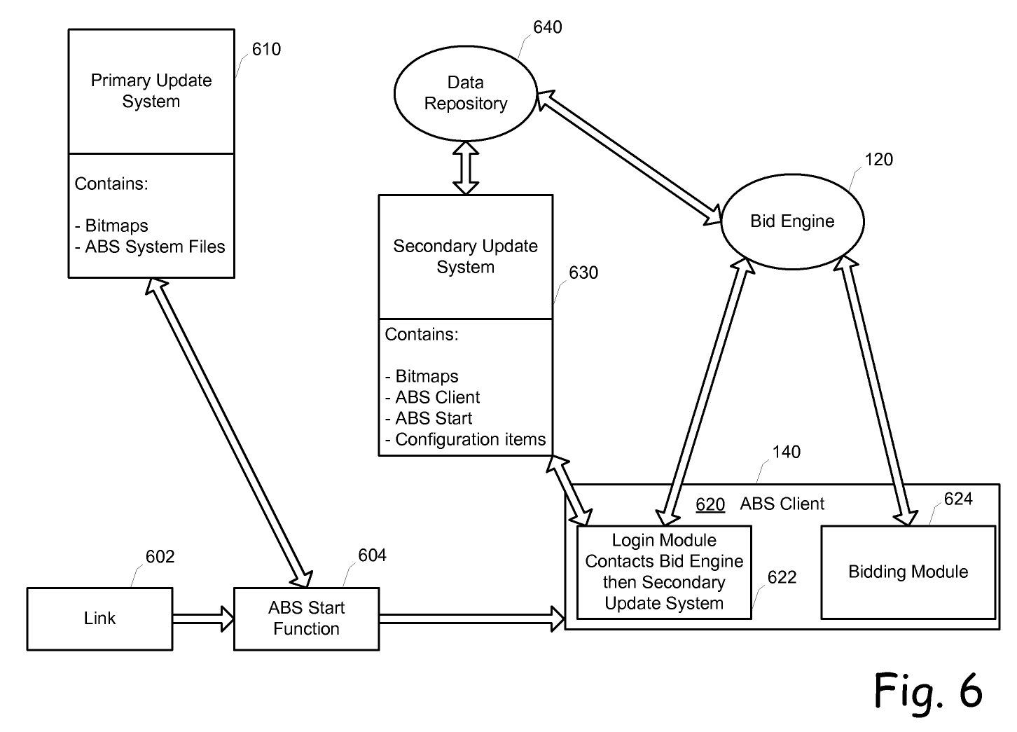

FIG. 6 is a state diagram illustrating the process for a bidder utilizing an exemplary embodiment of the handheld device 140 to join an auction event. If the bidder is using a handheld device 140 that has never been used to bid anonymously at an auction event using the ABS system, the bidder can be loaded with the initial software using an install set. This install set also places a setting within the registry of the handheld device 140 that creates an association between the appropriate file extensions and the ABS Start.

This process begins by a user of a handheld device 140 accessing a particular link or URL. The link address can be given to the user when the user registers to participate in the auction event. The user enters the link 602 into the handheld device 140, such as entering the URL in the browser address window. The handheld device then accesses a page associated with the link 602. The accessed page can include a JAVA script or similar executable file that invokes an ABS Start function 604.

The ABS start function 604 executes and communicates with the bid engine 120, which in turn transmits files to the handheld device 140 or it may obtain the core files from a separate system. The ABS start function 604 then reads the files and uses the tokens in the file as runtime parameters. Once the ABS Start function 604 has received or accessed the necessary files, the ABS start function 604 contacts a primary update system 610 and requests a list of the files and their respective checksums from the primary update system 610. In general, the files obtained from the primary update system 610 includes the core, low-level files necessary to bootstrap the handheld device. Thus, in an exemplary embodiment, these files can include necessary drivers, communication protocols, display drivers or the like. In addition, this process can be used to verify that the handheld device 140 is compatible with the ABS.

The ABS start function 604 compares the list of file names and their checksums available on the primary update system 610 against the files already loaded in the handheld device 140. If the ABS start function 604 determines that a file is missing, a checksum does not match, or a file is out of date, the ABS start function 604 tags the file name or places the filename in a list and, upon completion, requests the complete download of the list of files from the primary update system 610.

Following satisfactory receipt of all files, the ABS start function 610 evaluates the runtime parameters for the name of the application to execute after the files are received. As a result of the aforementioned processes, the handheld device 140 is fully loaded with the necessary software components to begin the configuration of the handheld device 140, or to bootstrap the handheld device 140. During the bootstrap process, the handheld device 140 is loaded with an ABS client application 620.

The ABS client application 620 running within the handheld device 140 searches the runtime parameters for the parameters which tell it what auction event to attend or to which bid engine 120 it should communicate (each auction event or lane receives its own bid engine). The ABS client application 620 includes a login module 622 and a bidding module 624. The login module 622, once invoked, requests the user to provide his user id and password so that he or she may be authenticated into the specific auction event. The handheld device 140 then transmits the user id and password to the bid engine 120 for authentication.

After processing a successful login or authentication, the secondary update system 630 contact information is read from the runtime parameters and the ABS client application 620 contacts the secondary update system 630. The ABS client application 620 requests a list of files and their respective checksums from the secondary update system 630. Once the files have been received from the secondary update system 630 and their checksums validated, the ABS client application 620 then sends a “download complete” message to itself. Upon receipt of the “download complete” message, the ABS client application 620 then sends a Get Inventory Data message to the secondary update system 630.

In response to receiving the Get Inventory Data message, the secondary update system 630 reads the auction event, inventory and status information from the data repository 640 and sends it to the ABS client application 620. The status information includes sold information for any items in the auction that have already been already sold (e.g. auction completed already). Once the auction event, inventory and status information has been successfully received by the ABS client application 620, the ABS client application 620 sends a “start current messages” message to the bid engine 120. The ABS client application 620 is now current with the auction and will begin receiving the normal auction messages.

At this point, the bidding module 624 becomes active and the user can enter into the bidding process for the current auction event.

It should be appreciated that the handheld device 140 does not have to go through this initialization process as described above and other techniques could also be employed to configure the handheld device 140 for operation within the ABS. For instance, the handheld devices 140 may come factory loaded with all the necessary software and hardware components to operate within the ABS. In such an embodiment, as bidders arrive at a live auction, they can be issued a handheld device 140 to operate within the ABS system. In another embodiment, a user possessing a compatible handheld device 140 can obtain a software download of the necessary software components via the Internet or through a wireless technology. In yet another embodiment, the user can purchase the software on a CDROM and upload the software into the handheld device 140 using a personal computer or similar apparatus.

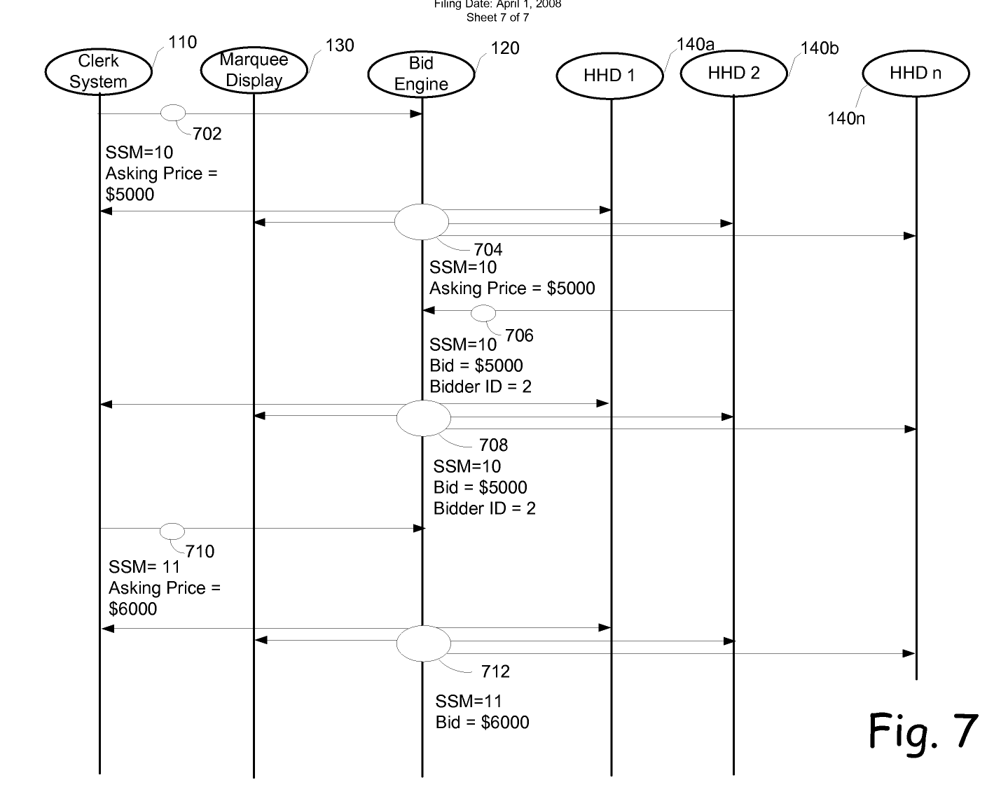

FIG. 7 is a state diagram illustrating the initial bid state. Each time an action event occurs on the clerk system 110 or the ABS client application 620 (handheld device) 140 a message is sent to the bid engine 120. Each message received by the bid engine 120 is then in turn sent to every client (clerk system 110, the marquee display 130 and the ABS client 620 running on the handheld device 140) connected to the bid engine 120, even if the client had originally transmitted the message. However, there are some messages that are replied to by the bid engine 120 and sent only to the originating client.

In one particular example, the administrator increments the asking price to $5,000 on the clerk system 110. The clerk system 110 then sends a message 702 to the bid engine 120 to indicate that the asking price is $5,000. This message 702 contains a special token within it, called the SSM (State Sequence Message number). For this example, the SSM is assigned a value say SSM=10 by the clerk. The bid engine 120 uses the SSM from the clerk as the golden SSM, and will set it's internal SSM equal to the value of the SSM value in any message from the clerk. The bid engine 120 then sends a message 704 of $5,000 to all the bidders, which also contains the SSM of 10. If Bidder 2 responds to the $5,000 amount and bids $5,000 706, the bid engine 120 determines that bidder 2's SSM=10 and relays the message 708 to the clerk system 110, all other bidders and the marquee display 130. The clerk system 110 evaluates the message to determine if the SSM=10 and if the clerk system's 110 SSM value is still 10, then the message is processed (bid is accepted) and bidder 2 is the now high bidder. The administrator then increments the clerk system's 110 asking price (i.e., to $6,000), with a SSM value of 11. This is then sent to the bid engine 120 in another message 710, which is then transmitted to all elements and to all clients in message 712.

### Handheld Device

The handheld device 140 depicted in FIG. 5 is simply one embodiment of the device. It should be appreciated that other handheld configurations may also be employed. Such handheld devices may be more complex or less complex than the illustrated handheld device. For instance, the handheld device may be a cellular telephone with data capabilities similar to what is available in GSM or GPRS technologies. The handheld device may be a PDA or laptop computer. On the other extreme, the handheld device may be as simple as a bombardier button or a simple fob with a bid button. In this embodiment, the handheld device, in its most simple form, may include a single transmission that occurs when a user presses the bid button. The transmission would include at the minimum, an identification portion, and may also include further information such as a bid indicator. It should be appreciated that any of the various configurations for a handheld device can be utilized in various embodiments of the present invention. When utilizing such a handheld device within the ABS, each bidder is issued a bidding fob that they can carry with them around the auction site. If a bidder wishes to participate in the auction, the bidder can silently place his or her bid by simply pressing the bid button. The effect of pressing the bid button is the same as if the bidder actually raised his or her hand on the auction floor and is recognized by the auctioneer. Thus, the bidder is able to participate in the auction in an anonymous fashion.

It will also be appreciated that although the device is described as being handheld, other embodiments of the device can also be incorporated into the present invention. For instance, the device may be a tethered device that is installed in a bidding booth. In addition, the device may be incorporated in the arm of a chair or the back panel of a chair thereby allowing bidders convenient access to the bidding device. The device may also be worn by the bidder as in a pendant type device.

Another advantage of the present invention is that all bidding activity can be run through the central system. In a traditional live auction setting, bidders raise hands, yippers yell out, and auctioneers chat away; however, the majority of the activity is not recorded except for the final awarding of the sale. The present invention allows all of the activity to be recorded so that the entire auction event can be analyzed. This data can be utilized to analyze the effectiveness of the auctioneer, the level of interest created by certain items that are offered for sale (or the lack thereof), as well as other trends and statistics relevant to the auctioning event.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of skilled in the art. The scope of the invention is limited only by the following claims.

What is claimed is:

1. A handheld device that is suitable for use within a tradition style auction setting, the device comprising:
a bid actuator that can be actuated by a user to initiate the entrance of a bid for an item in the auction;
a transmitter that is operable to transmit bid information to a receiving device; and
a processor that is operable to detect the actuation of the bid actuator, generate bid information and to cause the transmitter to transmit the bid information to the receiving device.

2. The handheld device of claim 1, wherein the transmitter utilizes wireless technology.

3. The handheld device of claim 1, wherein the bid information includes a bidder identity value that is not readily identifiable to the general public as to the actual identity of the user, and a request to place a bid.

4. The handheld device of claim 1, further comprising:
a receiver that is operable to receive item information pertaining to an item that is being auctioned for sale;
a display device; and
the processor is further operable to detect the reception of item information and to cause the display device to display at least a portion of the item information.

5. The handheld device of claim 3, wherein the receiver is further operable to receive bid status information and the processor is further operative to cause the display device to display at least a portion of the bid status information.

6. The handheld device of claim 5, wherein the bid status information includes the identification of the current high bid amount.

7. The handheld device of claim 3, further comprising:
location identification technology; and
the processor is further operative to cause the transmitter to transmit the location of the handheld device.

8. The system for enabling the entrance of anonymous bids into a traditional style live auction, the system comprising:
a plurality of bidding devices;
a bid engine function that is communicatively coupled to each of the plurality of bidding devices;
a clerk function that is communicatively coupled to the bid engine function and operable to:
access item information related to an item to be offered for auction,
receive bidding parameters,
provide the item information and the bidding parameters to a bid engine function, and
receive bidding requests from the bid engine function;
the bid engine function being operable to:
receiving the item information and the bidding parameters;
transmit the item information and the bidding parameters to each of the plurality of bidding devices;
receiving the bidding requests from one or more of the plurality of bidding devices, and
provide the bidding requests to the clerk system function;
each of the plurality of bidding devices being operable to:
receiving the item information and the bidding parameters from the bid engine function,
receiving a bid actuation,
translate the bid actuation into a bidding request, and
transmit the bidding request to the bid engine function.

9. The system of claim 8 wherein the bidding request includes an anonymous bidder identification.

10. The system of claim 9, wherein the bidding device further comprises a user interface that comprises a bid actuator, which when actuated by a users, generates a bid actuation.

11. The system of claim 10, wherein the user interface of the bidding device further comprises:
a bid status display that indicates a current high bid; and
displays at least a portion of the item information.

12. The system of claim 10, wherein the user interface of the bidding device further comprises a connection status indicator.

13. The system of claim 9, further comprising a marquee display visible by participant in the auction, and the bid engine function is further operable to:
transmit the item information and the bidding parameters to the marquee display; and
transmit the bidding request to the marquee display.

14. The system of claim 9, wherein the clerk function is further operable to:
record the item information and the bidding parameters; and
record each bidding requests from the one or more of the plurality of bidding devices.

15. A method for enabling bidders to anonymously participate in a live auction event, the method comprising the steps of:
providing each of a plurality of bidders with a bidding device, each bidding device having an associated and unique bidder identification;
delivering to each of the plurality of bidders, information about an item that is being auctioned;
establishing a requested bid amount;
receiving bid requests from one or more of the bidding devices, each bid request including the unique bidder identification associated with the bidding device entering the bid;
accepting one of the bid requests and identifying the unique bidder identification associated with the accepted bid request, whereby the bidder remains anonymous.

16. The method of claim 15, wherein each bidding device includes a bid actuator, and the step of receiving a bid request further comprises the steps of:
actuating the bid actuator on a bidding device; and
transmitting from the bidding device, a signal that indicates a bid request is being made, the signal including the unique bidder identification.

17. The method of claim 16, wherein each bidding device includes a display, and the step of delivering to each of the plurality of bidders, information about an item that is being auctioned further comprises transmitting information about the item that is being auctioned to the plurality of bidding devices, and each bidding device displaying at least a portion of the information.

18. The method of claim 16, wherein each bidding device includes a display, and the step of establishing a requested bid amount further comprises transmitting bidding parameter values to the plurality of bidding devices, and each bidding device displaying at least a portion of the bidding parameter values.

19. The method of claim 18, wherein the bidding parameter values comprise a current high bid amount and a current high bidder identifier.

20. The method of claim 15, wherein the step of accepting one of the bid requests and identifying the unique bidder identification associated with the accepted bid request, further comprises displaying on a marquee display located at the live auction event, the current high bid amount and the current high bidder identification.
